(19) United States
(12) Patent Application Publication
(10) Pub. No.: US 2009/0103243 A1
(43) Pub. Date: Apr. 23, 2009

(54) MULTITERMINAL SOLID ELECTROLYTIC CAPACITOR

(75) Inventors: Takashi Mizukoshi, Sendai-shi (JP); Koji Sakata, Sendai-shi (JP); Katsuhiro Yoshida, Sendai-shi (JP); Tetsuya Yoshinari, Sendai-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NEC TOKIN Corporation, Sendai-shi (JP)

(21) Appl. No.: 12/253,401

(22) Filed: Oct. 17, 2008

(30) Foreign Application Priority Data
Oct. 19, 2007 (JP) 2007-272553

(51) Int. Cl. H01G 9/00

(52) U.S. Cl. 361/523

(57) ABSTRACT

A multiterminal solid electrolytic capacitor includes a capacitor element including a porous sintered body which includes a plurality of anode leads projecting from a surface of the porous sintered body and which is made from a valve metal powder, a dielectric oxide coating disposed on the porous sintered body, and a cathode including a solid electrolyte layer disposed on the dielectric oxide coating. The multiterminal solid electrolytic capacitor further includes a substrate which carries the capacitor element, which includes a plurality of anode-mounting terminals and a cathode-mounting terminal, and which is covered with resin. The anode leads are portions of a valve metal pattern which extends in the porous sintered body and which bends at a plurality of locations so as to have a desired path length.

This application is based upon and claims the benefit of priority from Japanese patent application No. 2007-272553, filed on Oct. 19, 2007, the disclosure of which is incorporated herein in its entirety by reference.

### BACKGROUND OF THE INVENTION

1. Field of the Invention

The present invention relates to solid electrolytic capacitors and particularly relates to a multiterminal solid electrolytic capacitor.

2. Description of the Related Art

Solid electrolytic capacitors using as anode a valve, or valve action, metal such as tantalum or niobium are compact, have high capacitance and good frequency properties, and therefore are widely used in decoupling circuits or power supply circuits for central processing units (CPUs).

The performance increase of recent electronic devices increases the operation speed of semiconductor devices and the like; hence, high-frequency noise tends to occur. High-frequency noise causes problems such as equipment errors and howls and therefore is filtered out with decoupling circuits. Hence, the decoupling circuits need to be designed to cope with the high-speed operation of apparatuses. Furthermore, measures need to be taken against the increase in equipment power consumption and sharp current fluctuations due to sharp load changes.

In the case where a decoupling circuit is designed to cope with the increase in the operation speed and the increase in the power consumption of electronic equipment, the use of conventional electronic components allows the decoupling circuit to have a large size. This reverses the trend of reducing the size or thickness of electronic equipment. Therefore, the decoupling circuit needs to be simple and elements used therein need to have a small size and high performance.

Characteristics in decoupling circuits for filtering out noise and electronic components used in circuits can be known by measuring transmission loss thereof. S21, which is not described herein in detail, is one of parameters obtained by measuring the S-parameter with a network analyzer and represents transmission loss. In particular, S21 is a parameter that represents the transmittance of an input signal through a target circuit or a target electronic component. The less the value of S21, the greater the absorbance of noise.

In order to filter out high-frequency noise, decoupling circuits need to be designed or electronic components need to be improved such that S21 has a small value at high frequencies.

In particular, for a simple decoupling circuit including a plurality of two-terminal capacitors arranged in parallel between transmission paths including a signal line and a GND line, the value of S21 can be reduced in such a manner that the equivalent series resistance (ESR) and/or equivalent series inductance (ESL) of a capacitor is reduced and the capacitance (C) thereof is increased.

For a multiterminal capacitor such as a three- or four-terminal capacitor, electrodes arranged in an element are improved in structure such that a signal current flowing from a signal input terminal to a signal output terminal always passes through the capacitor. Therefore, an inductance component is arranged into a signal line in series and thereby an inductance component, due to a lead wire, causing the ESL of a two-terminal capacitor to be increased can be reduced. This reduces the value of S21 to improve the effect of filtering out high-frequency noise.

An example of the multiterminal capacitor is disclosed in Japanese Unexamined Patent Application Publication No. 2003-332173. In particular, Japanese Unexamined Patent Application Publication No. 2003-332173 discloses that the ESL of a capacitor is reduced by the use of a plurality of anode leads projecting from a surface of a porous sintered body.

### SUMMARY OF THE INVENTION

The inventors have investigated capacitors which include anode leads and which cope with sharp load changes or sharp current fluctuations due to the increase in the operation speed of electronic equipment.

It is an object of the present invention to provide a capacitor capable of filtering out the high-frequency noise caused by sharp load changes or sharp current fluctuations due to the increase in the operation speed of electronic equipment.

It is another object of the present invention to provide a capacitor capable of reducing the voltage drops across internal inductance components due to sharp load changes or sharp current fluctuations caused by the increase in the operation speed of electronic equipment.

It is a further object of the present invention to provide a decoupling circuit including a capacitor capable of coping with sharp load changes or sharp current fluctuations due to the increase in the operation speed of electronic equipment.

An aspect of the present invention provides a solid electrolytic capacitor that includes a porous sintered body which includes a plurality of anode leads projecting from a surface of the porous sintered body and which is made from a valve metal powder, a dielectric oxide coating disposed on the porous sintered body, and a cathode including a solid electrolyte layer disposed on the dielectric oxide coating. The anode leads are portions of a valve metal pattern which extends in the porous sintered body and which bends at a plurality of locations so as to have a desired path length. The valve metal pattern portions project out of the porous sintered body.

Another aspect of the invention provides a multiterminal solid electrolytic capacitor which comprises: a capacitor element including a porous sintered body which includes a plurality of anode leads projecting from a surface of the porous sintered body and which is made from a valve metal powder, a dielectric oxide coating disposed on the porous sintered body, and a cathode including a solid electrolyte layer disposed on the dielectric oxide coating; and a substrate which carries the capacitor element, which includes a plurality of anode-mounting terminals and a cathode-mounting terminal, and which is covered with resin. The anode leads are portions of a valve metal pattern which extends in the porous sintered body and which bends at a plurality of locations so as to have a desired path length, the valve metal pattern portions project out of the porous sintered body, a first anode lead that is one of the anode leads is electrically connected to a first anode-mounting terminal that is one of the anode-mounting terminals, and a second anode lead that is one of the anode leads is electrically connected to a second anode-mounting terminal that is one of the anode-mounting terminals.

The valve metal pattern may be a foil, a plate, or a thin film formed by pressing a wire.

A still another aspect of the invention provides a multiterminal solid electrolytic capacitor which comprises: a capacitor element including a porous sintered body which includes a plurality of anode leads projecting from a surface of the porous sintered body and which is made from a valve metal powder, a dielectric oxide coating disposed on the porous sintered body, and a cathode including a solid electrolyte layer disposed on the dielectric oxide coating; and a substrate which carries the capacitor element and which includes a plurality of anode-mounting terminals and a cathode-mounting terminal. The anode leads are portions of a valve metal pattern which extends in the porous sintered body and which bends at a plurality of locations so as to have a desired path length, the valve metal pattern portions project out of the porous sintered body, a first anode lead that is one of the anode leads is electrically connected to a first anode-mounting terminal that is one of the anode-mounting terminals, and a second anode lead that is one of the anode leads and a third second anode lead that is one of the anode leads are connected to each other in parallel in a path reaching a second anode-mounting terminal that is one of the anode-mounting terminals.

In an embodiment of the invention, the inductances from the porous sintered body to the anode-mounting terminals are preferably different from each other.

In an embodiment of the present invention, the anode leads, which project from the porous sintered body, have different shapes.

In an embodiment of the present invention, the anode leads, which project from the porous sintered body, are electrically connected to the substrate, which is a portion of the capacitor, in different ways and the connections between the anode leads and the substrate have different shapes.

A further aspect of the invention provides a multiterminal solid electrolytic capacitor which comprises: a capacitor element including a porous sintered body which includes a plurality of anode leads projecting from a surface of the porous sintered body and which is made from a valve metal powder, a dielectric oxide coating disposed on the porous sintered body, and a cathode including a solid electrolyte layer disposed on the dielectric oxide coating; and a substrate which carries the capacitor element, which includes a plurality of anode-mounting terminals and a cathode-mounting terminal, and which is covered with resin. The anode leads are portions of a valve metal pattern which extends in the porous sintered body and which bends at a plurality of locations so as to have a desired path length, the valve metal pattern portions project out of the porous sintered body, and the inductance of a path extending from one of the mounting terminals to the porous sintered body through one of the anode leads is different from the inductance a path extending from another one of the mounting terminals to the porous sintered body through another one of the anode leads.

A further aspect of the invention provides a decoupling circuit which comprises the multiterminal solid electrolytic capacitor according to the present invention; wherein one of the mounting terminals that is connected to a path having a lower inductance is connected to a load and one of the mounting terminals that is connected to a path having a higher inductance is connected to a power supply.

A further aspect of the present invention provides a decoupling circuit including a multiterminal solid electrolytic capacitor. The multiterminal solid electrolytic capacitor includes a capacitor element including a porous sintered body which includes a plurality of anode leads projecting from a surface of the porous sintered body and which is made from a valve metal powder, a dielectric oxide coating disposed on the porous sintered body, and a cathode including a solid electrolyte layer disposed on the dielectric oxide coating. The multiterminal solid electrolytic capacitor further includes a substrate which carries the capacitor element, which includes a plurality of anode-mounting terminals and a cathode-mounting terminal, and which is covered with resin. The anode leads are portions of a valve metal pattern which extends in the porous sintered body and which bends at a plurality of locations so as to have a desired path length. The valve metal pattern portions project out of the porous sintered body. A first anode lead that is one of the anode leads is electrically connected to a first anode-mounting terminal that is one of the anode-mounting terminals. A second anode lead that is one of the anode leads is electrically connected to a second anode-mounting terminal that is one of the anode-mounting terminals. When the inductance from the porous sintered body to the first anode-mounting terminal through the first anode lead is less than the inductance from the porous sintered body to the first anode-mounting terminal through the second anode lead, the first anode-mounting terminal is connected to a power supply and the second anode-mounting terminal is connected to a load.

Since the anode leads are the portions of the valve metal pattern, which extends in the porous sintered body and bends at a plurality of locations so as to have a desired path length, the portions projecting out of the porous sintered body, S21 representing the transmission loss at high frequencies can be reduced and the effect of filtering out high-frequency noise can be improved.

According to an embodiment of the present invention, a decoupling circuit is configured using a capacitor in which the inductance of a path extending from one of mounting terminals to a porous sintered body through one of anode leads is different from the inductance of a path extending from another one of the mounting terminals to the porous sintered body through another one of anode leads. One of the mounting terminals that is connected to one of the paths that has a lower inductance is connected to a load. One of the mounting terminals that is connected to one of the paths that has a higher inductance is connected to a power supply. Therefore, the voltage drop that occurs when the capacitor supplies the load with a current can be reduced.

### BRIEF DESCRIPTION OF THE DRAWINGS

The above features and advantages of the present invention will be more apparent from the following description of embodiments taken in conjunction with the accompanying drawings, in which:

FIG. 1 is a perspective view of a solid electrolytic capacitor according to an embodiment of the present invention;

FIG. 2A is a plan view of a capacitor element-connecting surface of a substrate included in the solid electrolytic capacitor shown in FIG. 1;

FIG. 2B is a plan view of the rear surface of the substrate shown in FIG. 2A, that is, a capacitor external mounting surface thereof;

FIG. 3 is an illustration showing anode leads of a capacitor element used in Example 1 and the pattern of portions of the anode leads that extends in the capacitor element;

FIG. 4 is an illustration showing anode leads of a capacitor element used in Example 2 and the pattern of portions of the anode leads that extends in the capacitor element;

FIG. 5A is a perspective view of a capacitor prepared in Example 3;

FIG. 5B is an illustration showing anode leads of a capacitor element included in the capacitor shown in FIG. 5 and the pattern of portions of the anode leads that extends in the capacitor element;

FIG. 6A is a plan view of a capacitor element-connecting surface of a substrate used in Example 3;

FIG. 6B is a plan view of the rear surface of the substrate shown in FIG. 6A, that is, a capacitor external mounting surface thereof;

FIG. 7 is an illustration showing anode leads of a capacitor element used in Example 4 and the pattern of portions of the anode leads that extends in the capacitor element;

FIG. 8A is a plan view of a capacitor element-connecting surface of a substrate used in Example 4;

FIG. 8B is a plan view of the rear surface of the substrate shown in FIG. 8A, that is, a capacitor external mounting surface thereof;

FIG. 9 is a plan view of a capacitor prepared in Comparative Example 1;

FIG. 10 is an illustration showing anode leads of a capacitor element used in Comparative Example 2 and the pattern of portions of the anode leads that extends in the capacitor element;

FIG. 11 is a diagram of a simple equivalent circuit of a four-terminal solid electrolytic capacitor used to describe features of an embodiment of the present invention; and

FIGS. 12A and 12B are equivalent circuit diagrams used to describe features of embodiments of the present invention.

### DESCRIPTION OF THE EXEMPLARY EMBODIMENTS

An embodiment of the present invention will now be described with reference to the accompanying drawings using a four-terminal solid electrolytic capacitor as an example.

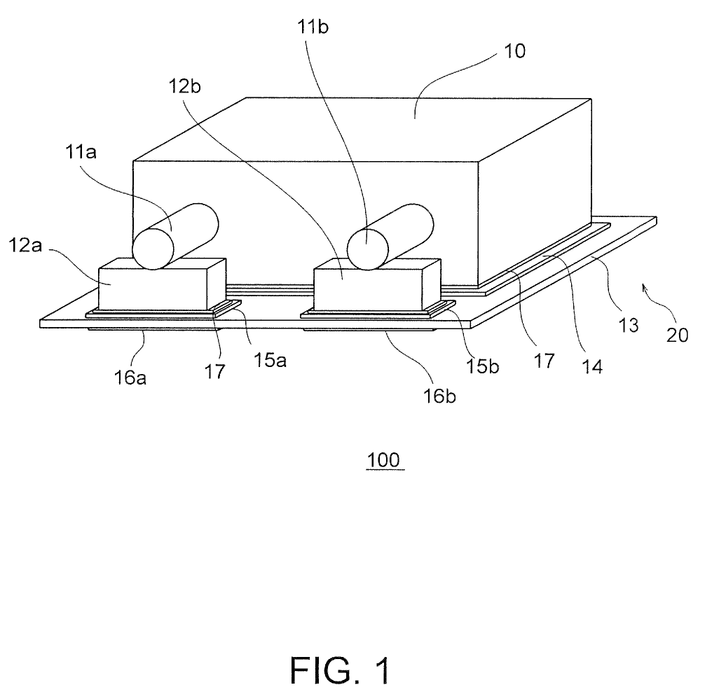

FIG. 1 shows a solid electrolytic capacitor 100 which includes a capacitor element 10 and a substrate 20 for fixing the capacitor element 10. The capacitor element 10 includes two anode leads 11a and 11b projecting from a surface of the capacitor element 10. The anode leads 11a and 11b project from a surface of a porous sintered body that is prepared in such a manner that a valve metal powder is pressed into a compact, which is then vacuum-sintered as described below in detail. A valve metal pattern extends in the porous sintered body, bends at a plurality of locations, and has portions projecting out of the porous sintered body. The projecting portions are the anode leads 11a and 11b. That is, the anode leads 11a and 11b are the projecting portions of the valve metal pattern, which extends in the porous sintered body and bends at a plurality of locations so as to have a desired path length. These are described in examples below. The porous sintered body is coated with a dielectric oxide coating. The dielectric oxide coating is overlaid with a solid electrolyte layer. The solid electrolyte layer is overlaid layer including a graphite sublayer and a silver paste sublayer with which the solid electrolyte layer constitutes a cathode layer.

The anode leads 11a and 11b are fixed to metal-made ties 12a and 12b, respectively, acting as support members by laser welding or resistance welding. The capacitor element 10 is fixed to the substrate 20 with the ties 12a and 12b. A surface of the substrate 20 above which the capacitor element 10 is disposed carries a cathode-connecting portion 14 connected to the capacitor element 10 and also carries anode lead tie-connecting portions 15a and 15b. The ties 12a and 12b are fixed to the anode lead tie-connecting portions 15a and 15b, respectively, with a conductive adhesive 17. The ties 12a and 12b may be fixed to the anode lead tie-connecting portions 15a and 15b, respectively, by high-temperature soldering, laser welding, or resistance welding instead of using the conductive adhesive 17. The capacitor element 10 is fixed in the cathode layer to the cathode-connecting portion 14 with the conductive adhesive 17.

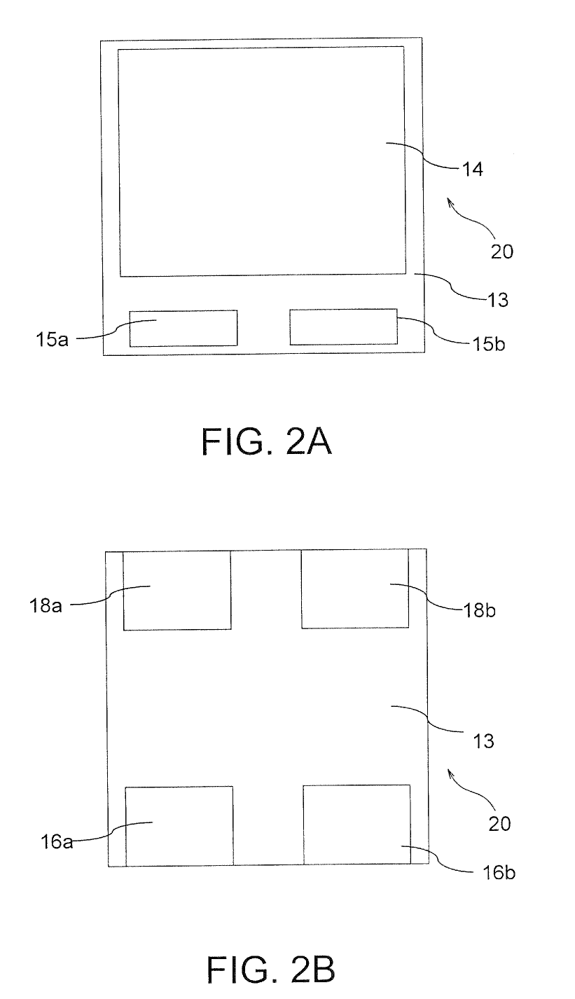

The substrate 20 is further described below in detail with reference to FIGS. 2A and 2B. FIG. 2A shows a surface of the substrate 20 that is opposed to the capacitor element 10 and that is connected to the capacitor element 10. With reference to FIG. 2A, the substrate 20 includes an insulating resin sheet 13 carrying a rectangular conductive pattern 14 and rectangular conductive patterns 15a and 15b. The conductive pattern 14 is to be the cathode-connecting portion 14 and the conductive patterns 15a and 15b are to be the anode lead tie-connecting portions 15a and 15b.

FIG. 2B shows a surface of the substrate 20 that is opposite to that surface. This surface carries mounting surface electrodes that are to be terminals arranged on an external mounting surface of a capacitor. That is, the rear surface of the insulating resin sheet 13 carries capacitor-mounting surface anode terminals 16a and 16b and capacitor-mounting surface cathode terminals 18a and 18b. The mounting surface electrodes are made from conductive patterns. Two mounting anode terminals and two mounting cathode terminals form a four-terminal mounting surface electrode.

The insulating resin sheet 13 is primarily made of a glass-epoxy composite, polyimide, or a bismaleimide-triazine (BT) resin and may be made of a liquid crystal polymer (LCP), polyether ether ketone (PEEK), or the like. The insulating resin sheet 13 preferably has a thickness of about 10 to 80 μm.

The conductive patterns and mounting terminals arranged on a capacitor element-connecting surface and a capacitor-mounting electrode surface each include a conductive portion made of copper plated with gold and preferably have a thickness of about 10 to 60 m. For cost reduction, the conductive portion may be coated with a preflux instead of being plated with gold.

The capacitor-mounting electrode surface can be improved in mountability and migration resistance in such a manner that a solder resist layer, which is not shown, is formed on the capacitor-mounting electrode surface so as to have a thickness of about 10 to 20 μm. Furthermore, the capacitor element-connecting surface can be improved in migration resistance in such a manner that a solder resist may be applied onto the capacitor element-connecting surface.

In the conductive portions disposed on the capacitor element-connecting surface and the capacitor-mounting electrode surface, the anode lead tie-connecting portions 15a and 15b are electrically connected to the capacitor-mounting surface anode terminals 16a and 16b, respectively, and the cathode-connecting portion 14 is electrically connected to the capacitor-mounting surface cathode terminals 18a and 18b through via-holes. The greater the number of the via-holes, the less ESR and/or ESL. In consideration of cost and the like, the number of the via-holes is preferably one to five.

With reference back to FIG. 1, the solid electrolytic capacitor 100 includes a resin cover, which is not shown. The cover is formed by injection molding, transfer molding, or the like from a heat-resistant resin, such as a liquid epoxy resin, polyphenylene sulfide (PPS), PEEK, or LCP, resistant to lead-free solder reflowing. The cover is formed over a plurality of capacitor elements and then diced into capacitors having a predetermined size.

### EXAMPLE 1

A sample with outer dimensions of 3.5 mm×2.8 mm×1.9 mm was prepared in this example.

A procedure for preparing a capacitor element 10 containing tantalum, which is a valve metal, is described below. A tantalum powder is pressed around a tantalum wire with a press and then sintered at high temperature in a high vacuum, whereby a porous sintered body is obtained. An oxide coating made of Ta₂O₅ is formed on the porous sintered body. After the porous sintered body is dipped in a manganese nitrate solution, a MnO₂ layer is formed on the porous sintered body by thermal decomposition. Graphite and silver layers are formed over the oxide coating, respectively, whereby the capacitor element 10 is obtained. If a conductive polymer such as polythiophene or polypyrrole is used instead of MnO₂, which is a part of the cathode layer, a capacitor element having low ESR can be obtained. Examples of a usable valve metal other than tantalum include niobium, aluminum, and titanium.

Two portions of the tantalum wire are extended from a surface of the capacitor element 10, whereby anode leads 11a and 11b are formed. Since the anode leads 11a and 11b project from the capacitor element surface in the same direction, an apparatus and/or a process, such as dipping, used to manufacture a conventional two-terminal solid electrolytic capacitor can be used.

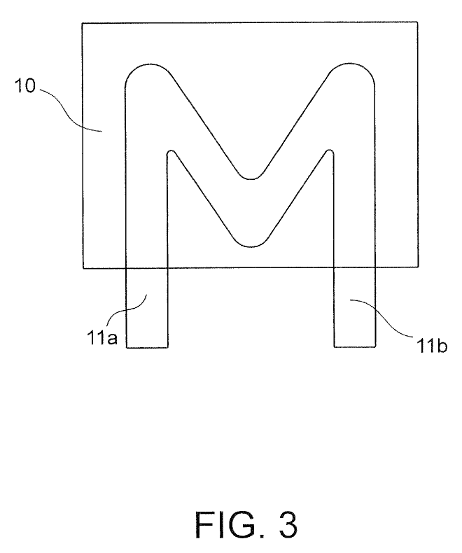

The relationship between the inside of the capacitor element 10 and the anode leads 11a and 11b is described below with reference to FIG. 3. FIG. 3 is a plan view of the tantalum wire extending in the capacitor element 10. The tantalum wire has a diameter of about 0.3 μm. The tantalum wire is bent with a dedicated tool so as to have a shape as shown in FIG. 3 and is used to form the anode leads 11a and 11b. The anode leads 11a and 11b are both end portions of the tantalum wire that project out of the porous sintered body. The tantalum wire extends through the porous sintered body and bends at a plurality of locations so as to have a desired path length. The anode leads 11a and 11b extend in parallel to each other. The distance between the centers of the anode leads 11a and 11b is about 2.0 mm. The tantalum wire, which extends in the porous sintered body, has an M-shape. Therefore, the tantalum wire has three bent portions. The tantalum wire has a shape symmetric with respect to the center line between the anode leads 11a and 11b.

With reference to FIGS. 1 and 3, the anode leads 11a and 11b are fixed to the ties 12a and 12b, respectively, by resistance welding. In this example, the ties 12a and 12b are made of Alloy 42 plated with tin. A mother material used to form the ties 12a and 12b may be copper, stainless steel, or the like. The ties 12a and 12b may be plated with gold, palladium, or the like instead of tin.

A substrate used includes an insulating resin sheet made a glass-epoxy composite and conductive portions made of copper plated with gold. The insulating resin sheet has a thickness of about 60 μm. The conductive portions have a thickness of about 20 μm and are disposed on the upper and lower surfaces of the insulating resin sheet. The substrate therefore has a thickness of about 100 μm. An epoxy-based conductive adhesive 17 containing silver is applied onto anode lead tie-connecting portions 15a and 15b and cathode-connecting portion 14 disposed on the substrate. The ties 12a and 12b are welded to the anode lead tie-connecting portions 15a and 15b, respectively. The capacitor element 10 is mounted on the cathode-connecting portion 14 and the epoxy-based conductive adhesive 17 is then cured at 150° C. for 30 minutes, whereby the capacitor element 10 is bonded to the substrate.

In actual manufacture, 200 triplets of conductive patterns identical to those formed on a capacitor element-connecting surface as shown in FIG. 2A are provided on the front surface of an insulating resin sheet having a size sufficient to carry 200 completed capacitors arranged in 20 rows and ten columns. Two hundred quartets of patterns identical to those formed on a capacitor-mounting electrode surface as shown in FIG. 2B are provided on the rear surface of this insulating resin sheet. Capacitor elements are provided on and then fixed to the conductive patterns arranged on the front surface of this insulating resin sheet. A liquid epoxy resin is used to form a resin cover. In particular, the liquid epoxy resin is potted onto a wafer including this insulating resin sheet carrying the capacitor elements bonded thereto. The wafer is placed into a mold. After the mold is evacuated to a vacuum, the wafer is heated at 150° C. for three minutes under pressurized conditions, whereby the liquid epoxy resin is cured. The wafer is taken out of the mold and then heated at 150° C. for three hours, whereby the epoxy resin is completely cured. The resin cover may be molded in an ordinary transfer mold or the like. The wafer covered with the resin cover is then diced into chips having a target size.

### EXAMPLE 2

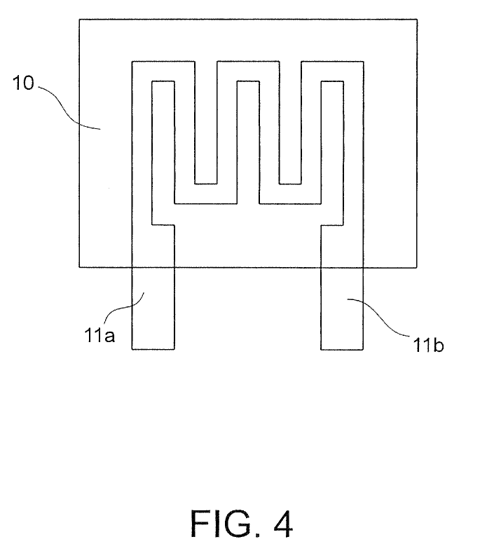

A first anode lead 11a and second anode lead 11b having a shape as shown in FIG. 4 were used. A valve metal pattern extends in a capacitor element and has a repeated shape. The first and second anode leads 11a and 11b are portions that extend from the valve metal pattern in substantially parallel to each other. Unlike the anode leads of Example 1, the first and second anode leads 11a and 11b were prepared in such a manner that a tantalum sheet with a thickness of 100 μm was punched with a die. The distance between the centers of the first and second anode leads 11a and 11b is 2.0 mm. The valve metal pattern has nine bent portions disposed in the capacitor element and has a shape symmetric with respect to the center line between the first and second anode leads 11a and 11b. Other portions are substantially the same as those described in Example 1.

### EXAMPLE 3

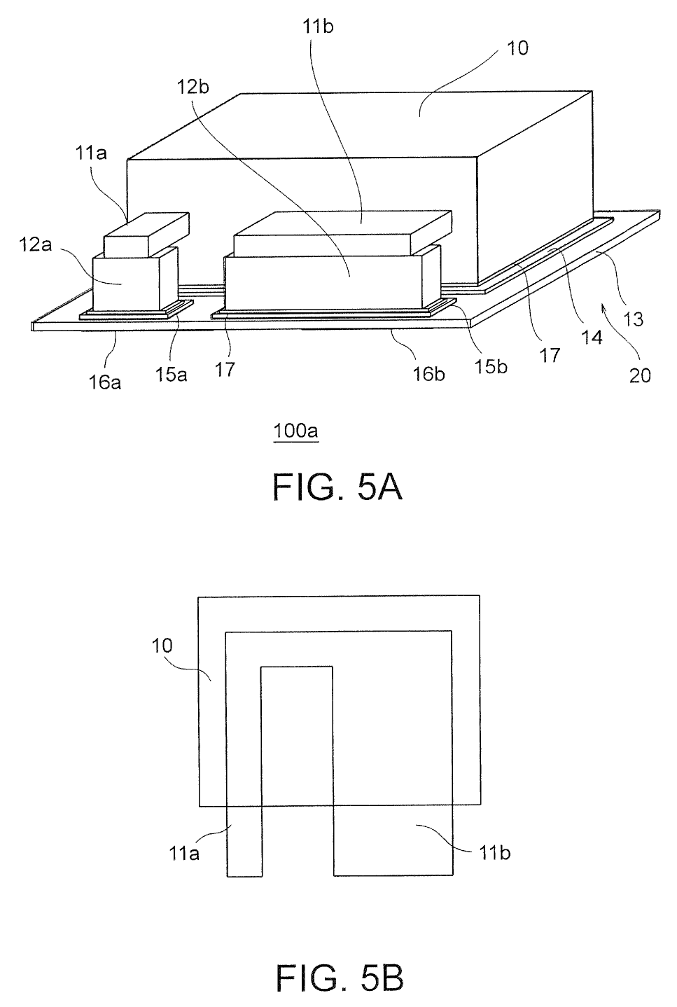

In this example, a capacitor 100a has a structure as shown in FIG. 5A.

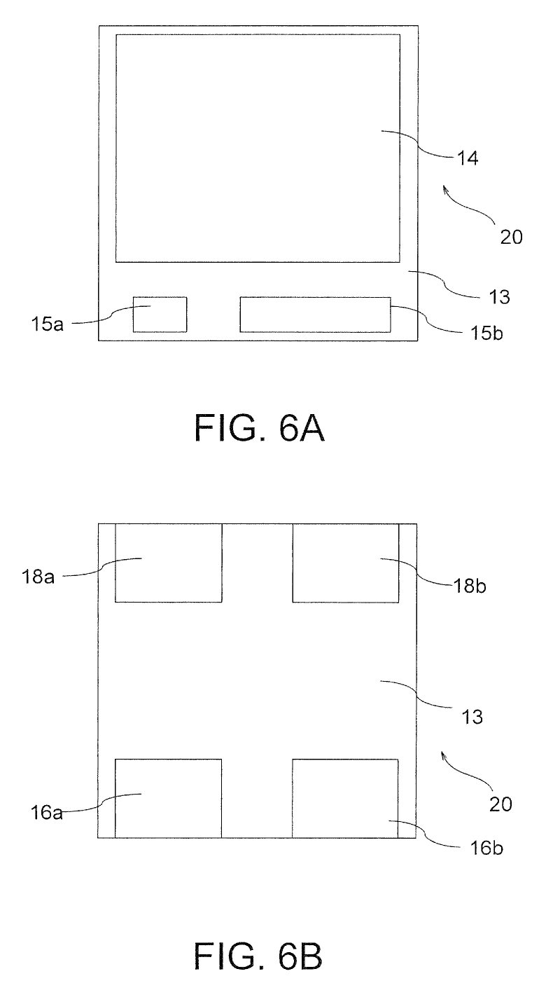

A first anode lead 11a and second anode lead 11b each having a shape as shown in FIG. 5B were used. The first and second anode leads 11a and 11b are different in shape from each other. The first and second anode leads 11a and 11b were designed such that the second anode lead 11b had an ESL less than that of the first anode lead 11a. There are two bent portions in a capacitor element used. The second anode lead 11b is wide and has an inner portion extending in the capacitor element at a constant width. The second anode lead 11b is wider than the first anode lead 11a; hence, ties have different sizes and anode lead tie-connecting portions have different sizes. In particular, a wide tie 12b is used for the second anode lead 11b having a greater width and a narrow tie 12a is used for the first anode lead 11a having a less width as shown in FIG. 5A. A wide anode lead tie-connecting portion 15b is used for the wide tie 12b as shown in FIG. 6A. FIG. 6B shows the arrangement of electrode terminals disposed on an outer mounting surface of a capacitor. This arrangement is the same as that shown in FIG. 2B. Other portions are substantially the same as those described in Example 2.

### EXAMPLE 4

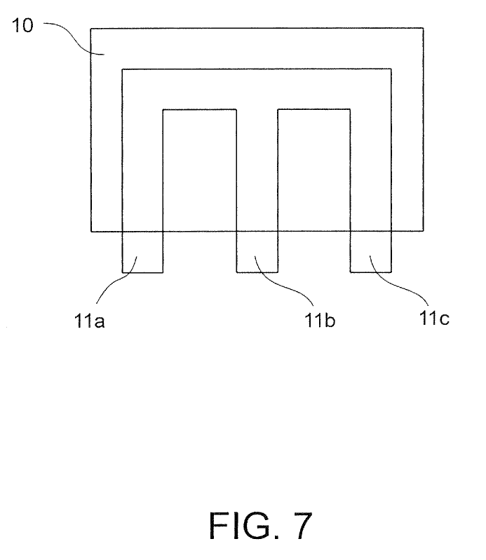

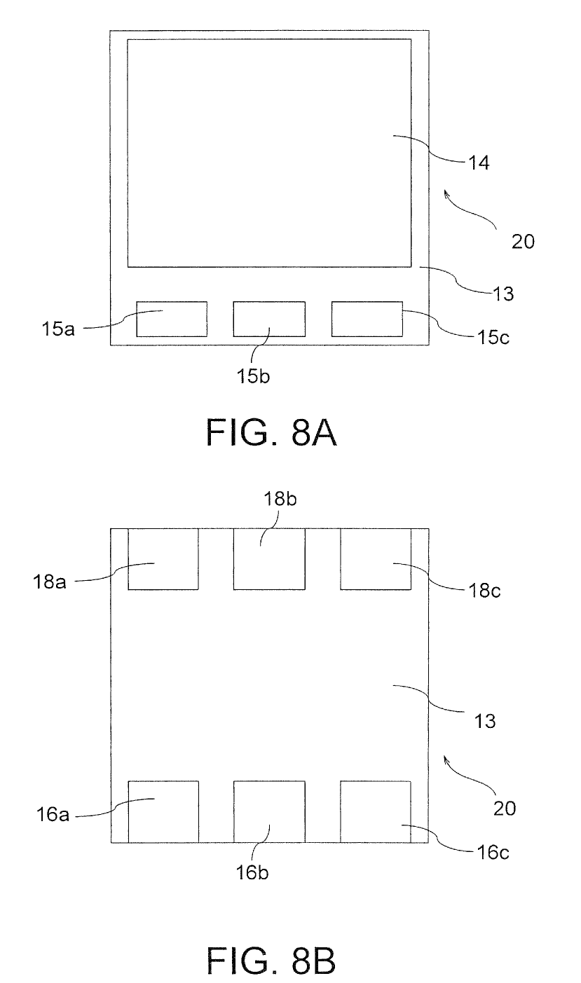

In this example, a capacitor with outer dimensions of 4.0 mm×2.5 mm×1.9 mm was prepared. With reference to FIG. 7, three anode leads project from a capacitor element and extend in parallel to each other. The three anode leads are connected to each other in the capacitor element. The three anode leads form a pattern symmetric with respect to the center anode lead. With reference to FIG. 8A, the following patterns are arranged on a surface of a substrate 20 that faces the capacitor element: a conductive pattern 14a acting as a cathode-connecting portion and three conductive patterns 15a, 15b, and 15c acting as tie-connecting portions. With reference to FIG. 8B, six electrodes are arranged on a capacitor-mounting surface of the substrate 20. Therefore, a six-terminal capacitor is obtained. Other portions are substantially the same as those described in Example 2.

### EXAMPLE 5

The following members were used as shown in FIG. 7: anode leads, a capacitor element, and a tantalum sheet pattern. The tantalum sheet pattern was disposed in the capacitor element. A capacitor element-connecting surface used had conductive patterns shown in FIG. 6A. The following ties were used: a small tie 12a corresponding to a small conductive pattern and a large tie 12b corresponding to a large conductive pattern. The small tie 12a and the large tie 12b each had a size as shown in FIG. 5A. A capacitor-mounting electrode surface was as shown in FIG. 6B and was the same as that shown in FIG. 2B.

An anode lead 11a corresponding to one of the three anode leads shown in FIG. 7A was connected to the small tie 12a and two anode lead 11b and 11c were connected to the large tie 12b in parallel (see FIG. 5A) to be electrically connected to an anode terminal 16b (see FIG. 6B) disposed on a mounting surface. Other portions are substantially the same as those described in Example 4.

### COMPARATIVE EXAMPLE 1

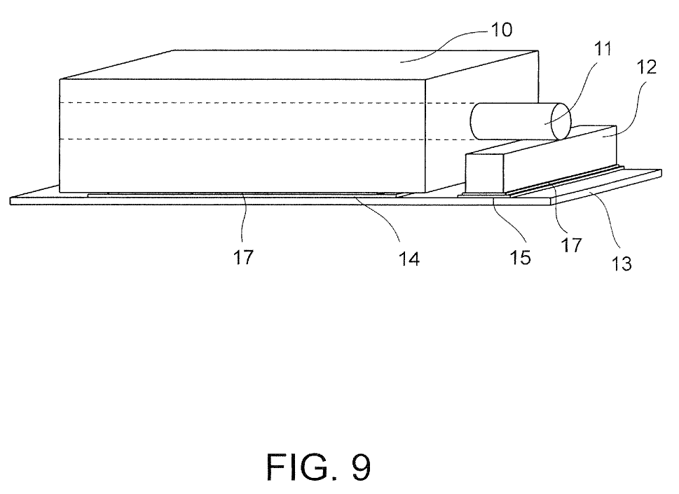

In Comparative Example 1, a two-terminal solid electrolytic capacitor shown in FIG. 9 was prepared. The two-terminal solid electrolytic capacitor includes an anode lead which projects from an end of a capacitor element 10 and which extends in the capacitor element 10. A substrate, conductive patterns 14 and 15, a conductive adhesive 17, and a tie are as shown in FIG. 9. A capacitor-mounting electrode surface has a shape as shown in FIG. 2B so as to have apparently four terminals. Other portions are substantially the same as those described in Example 1.

### COMPARATIVE EXAMPLE 2

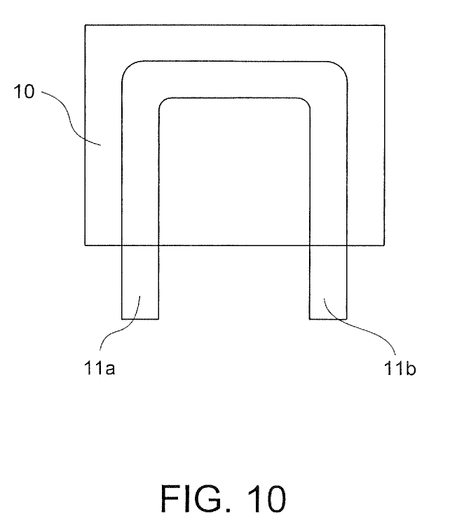

In Comparative Example 2, a capacitor element and anode leads shown in FIG. 10 were used. Portions of the anode leads extended in the capacitor element and had a shape as shown in FIG. 10. Other portions are substantially the same as those described in Example 1.

(a) Comparison of Volumetric Efficiency

Table 1 shows the volumetric efficiencies of the capacitor elements of Examples 1 to 5 and Comparative Examples 1 and 2. The volumetric efficiencies of the capacitor elements of Examples 1 to 5 and Comparative Example 2 are close to the volumetric efficiency of the capacitor element of Comparative Example 1. The capacitor element of Comparative Example 1 is a two-terminal type.

TABLE 1

| | Volumetric efficiencies of |
|---|---|
| | capacitor elements (%) |
| Examples 1 to 3 | 55 |
| Examples 4 and 5 | 53 |
| Comparative Example 1 | 57 |
| Comparative Example 2 | 55 |

(b) Comparison of S21 Parameter and Other Properties

Table 2 shows results obtained by measuring the solid electrolytic capacitors prepared in Examples 1 to 5 and Comparative Examples 1 and 2 for S21 (an S parameter representing the transmission loss: the less the value thereof, the high the noise absorption effect) with a network analyzer. The solid electrolytic capacitors of Examples 1 to 3 and 5 and Comparative Examples 1 and 2 were measured in such a manner that a capacitor-mounting surface anode terminal 16a and a capacitor-mounting surface cathode terminal 18a were connected to Port 1 of the network analyzer and a capacitor-mounting surface anode terminal 16b and a capacitor-mounting surface cathode terminal 18b were connected to Port 2 of the network analyzer. The solid electrolytic capacitor of Example 4 was measured in such a manner that a capacitor-mounting surface anode terminal 16a and a capacitor-mounting surface cathode terminal 18a were connected to Port 1 of the network analyzer, capacitor-mounting surface anode terminals 16b and 16c were directly connected to each other, capacitor-mounting surface cathode terminals 18b and 18c were directly connected to each other, and the capacitor-mounting surface anode terminals 16b and 16c and the capacitor-mounting surface cathode (terminals 18b and 18c were connected to Port 2 of the network analyzer.

TABLE 2

| | S21 (dB at 200 MHz) |
|---|---|
| Example 1 | −39.1 |
| Example 2 | −41.0 |
| Example 3 | −38.4 |
| Example 4 | −38.7 |
| Example 5 | −38.5 |
| Comparative Example 1 | −28.1 |
| Comparative Example 2 | −36.5 |

The solid electrolytic capacitors of Examples 1 to 5 and Comparative Example 2 have greatly improved transmission losses at high frequency (in these examples, a frequency of 200 MHz) as compared to the solid electrolytic capacitor of Comparative Example 1. The solid electrolytic capacitor of Comparative Example 1 is a two-terminal type and the solid electrolytic capacitors of Examples 1 to 5 and Comparative Example 2 are a multiterminal type.

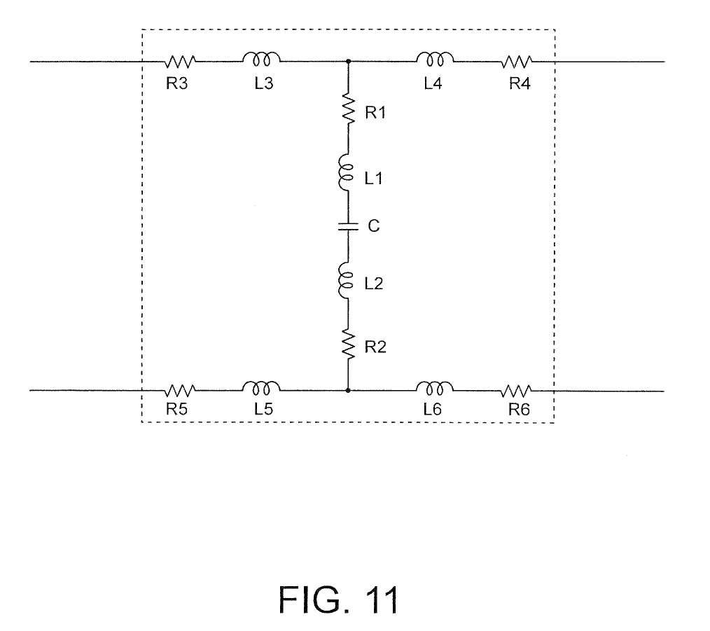

The solid electrolytic capacitors of Examples 1 and 2 are particularly superior in transmission loss to the solid electrolytic capacitor of Comparative Example 2. This is probably because long anode leads extend in porous sintered bodies. Suppose that this has a simple equivalent circuit of a four-terminal solid electrolytic capacitor shown in FIG. 11. The portions of anode leads extending in the porous sintered bodies are long and therefore inductances L3 and L4 are large. The contact area of the portions of the anode leads extending in the porous sintered body with the compact is large and therefore an inductance L1 is small; hence, the value of S21 is small.

The capacitors of Examples 3, 4, and 5 are substantially equal in transmission loss to the capacitor of Example 1. In the case where the capacitors of Examples 3, 4, and 5 are used as decoupling elements in such a manner that a power supply and a load are connected to a left portion and right portion, respectively, of the simple equivalent circuit of the four-terminal solid electrolytic capacitor shown in FIG. 11, voltage drops occur in the inductances L4 and L6 of the load side when the load is supplied with a current from a capacitor C; however, the influence of the voltage drops in the inductances L4 and L6 on sharp current fluctuations in the load can be reduced by reducing the inductances L4 and L6.

The effect of filtering out high-frequency noise is increased by increasing the sum of the inductances L3, L4, L5, and L6; hence, the reduction of the inductances L4 and L6 may reduce the effect of filtering out high-frequency noise. Therefore, in order to prevent the reduction of the effect of filtering out high-frequency noise and in order to effectively supply a current to the load from the capacitor C, a load-side inductance component is preferably small and a power supply-side inductance component is preferably large.

In the capacitor of Example 3, a power supply-side inductance component can be increased and a load-side inductance component can be reduced in such a manner that the narrow anode terminal 16a shown on the right side in FIG. 5A is connected to a power supply and the wide anode terminal 16b shown on the left side in FIG. 5A is connected to a load.

In the capacitor of Example 4, a load-side inductance component can be reduced to about half a power supply-side inductance component in such a manner that a pair of a positive terminal and a negative terminal are connected to a power supply, positive terminals of two other pairs are directly connected to each other and then connected to a load-side signal line, negative terminals of the two other pairs are directly connected to each other and then connected to a load-side GND line.

In the capacitor of Example 5, two of three anode leads are connected to a conductive pattern of a substrate disposed in the capacitor in parallel through ties, whereby the inductance between portions connected in parallel is reduced to half. This allows a load-side inductance to be small.

In order to prove that a load-side inductance can be reduced and the voltage drop in a portion supplied with a current form a power supply is reduced, voltage fluctuations caused by varying the current consumed by a load may be measured and then compared to each other in such a manner that a CPU is used as the load and the capacitor prepared in one of Examples 3 to 5 and Comparative Example 2 is used as a decoupling element. The capacitor is not designed to endure a large current necessary to drive the CPU. An electronic load may be used; however, it is difficult to prove the above phenomenon using such an electronic load because a current need to be increased in a short time less than one microsecond.

Accordingly, load connection side inductances were simulated from the shapes of the anode leads and terminal-connecting techniques used in the capacitors of Examples 3 to 5 and Comparative Example 2. Table 3 shows the simulation results (the inductance corresponds to the sum of the inductances L4 and L6 shown in FIG. 11). The capacitors of Examples 3 to 5 have smaller inductance as compared to the capacitor of Comparative Example 2. This suggests that the capacitors of Examples 3 to 5 are more greatly improved as compared to the capacitor of Comparative Example 2 in that the voltage drop due to the inductance of each capacitor during the supply of a current to a load from the capacitor is reduced.

TABLE 3

| | ESL (pH) |
|---|---|
| Example 3 | 42 |
| Example 4 | 39 |
| Example 5 | 38 |
| Comparative Example 2 | 61 |

In the capacitor of each of the Examples 3, 4, and 5, the inductance from a first anode-mounting terminal to the porous sintered body of the capacitor is different from the inductance from a second anode-mounting terminal to the porous sintered body. This can be readily understood as described below.

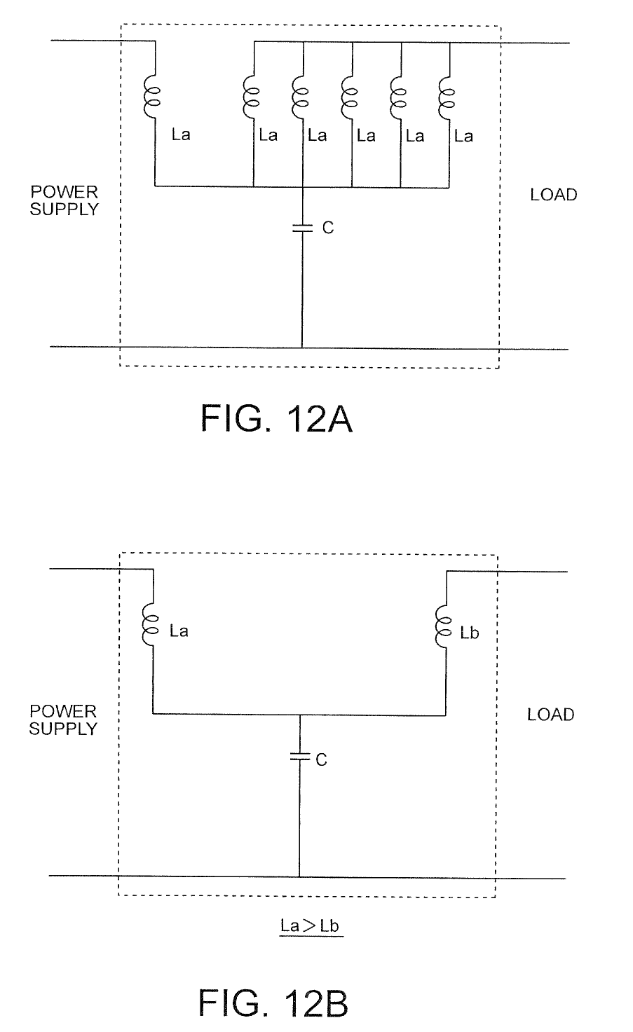

Suppose that, in the capacitors of Examples 4 and 5, the anode leads projecting from the porous sintered bodies have the same shape and the inductances from the anode leads to anode connection terminals are the same and are represented by La. In this case, an equivalent circuit of each capacitor is as shown in FIG. 12A, in which an inductor and resistor disposed in the capacitor are omitted. That is, the equivalent circuit can be configured such that a first anode connection terminal 16a is connected to a porous sintered body through an anode lead and a second anode connection terminal 16b is connected to the porous sintered body through a plurality of anode leads in parallel. Therefore, the inductance from the second anode-mounting terminal to the porous sintered body is less than the inductance from the first anode-mounting terminal to the porous sintered body.

An equivalent circuit of the capacitor of Example 3 is as shown in FIG. 12B, in which the number of anode leads is two and have different shapes, that is, a first anode lead has a width greater than that of a second anode lead. With reference to FIG. 12B, the inductance from a first mounting terminal connected to the first anode lead to a porous sintered body is large. This is because the inductance La of a path extending from a first anode-mounting terminal is greater than the inductance Lb of a path extending from a second anode-mounting terminal since the width of the first anode lead is small.

The examples of the present invention are as described above. The present invention is not limited to the examples. Various variations may be made. For example, a lead extending in a porous sintered body may have a meandering pattern. A coiled anode lead may be provided in a sintered body. Modifications within the scope of the present invention are covered by the present invention.

What is claimed is:

1. A multiterminal solid electrolytic capacitor comprising:
a capacitor element including a porous sintered body which includes a plurality of anode leads projecting from the porous sintered body and which is made from a valve metal powder, a dielectric oxide coating disposed on the porous sintered body, and a cathode including a solid electrolyte layer disposed over the dielectric oxide coating; and
a substrate which carries the capacitor element, which includes a plurality of anode-mounting terminals and a cathode-mounting terminal, and which is covered with resin,
wherein the anode leads are portions of a valve metal pattern which extends in the porous sintered body and which bends at a plurality of locations so as to have a desired path length, and the valve metal pattern portions project out of the porous sintered body;
wherein a first anode lead that is one of the anode leads is electrically connected to a first anode-mounting terminal that is one of the anode-mounting terminals; and
wherein a second anode lead that is one of the anode leads is electrically connected to a second anode-mounting terminal that is one of the anode-mounting terminals.

2. The multiterminal solid electrolytic capacitor according to claim 1, wherein the valve metal pattern is a foil, a plate, or a thin film formed by pressing a wire.

3. The multiterminal solid electrolytic capacitor according to claim 1, wherein the valve metal pattern and the first and second anode leads are symmetric with respect to the center line between the first and second anode leads.

4. The multiterminal solid electrolytic capacitor according to claim 1, wherein the substrate includes a cathode-connecting conductive pattern, a first conductive pattern for anode connection, and a second conductive pattern for anode connection and has a surface which is opposite to a surface that carries the anode-mounting terminals and the cathode-mounting terminal and on which the cathode-connecting conductive pattern, the first conductive pattern, and the second conductive pattern are arranged;
wherein the first conductive pattern and the second conductive pattern are connected to the first anode-mounting terminal and the second anode-mounting terminal, respectively;
wherein the cathode-connecting conductive pattern is connected to the cathode-mounting terminal;
wherein the cathode of the capacitor element is connected to the cathode-connecting conductive pattern;
wherein the first anode lead is connected to the first conductive pattern for anode connection through a first support member for anode lead connection; and
wherein and the second anode lead is connected to the second conductive pattern for anode connection through a second support member for anode lead connection.

5. The multiterminal solid electrolytic capacitor according to claim 1, wherein the first and second anode leads have different shapes.

6. The multiterminal solid electrolytic capacitor according to claim 1, wherein the inductance from the first anode-mounting terminal to the porous sintered body is greater than the inductance from the second anode-mounting terminal to the porous sintered body.

7. A multiterminal solid electrolytic capacitor comprising:
a capacitor element including a porous sintered body which includes a plurality of anode leads projecting from the porous sintered body and which is made from a valve metal powder, a dielectric oxide coating disposed on the porous sintered body, and a cathode including a solid electrolyte layer disposed over the dielectric oxide coating; and
a substrate which carries the capacitor element and which includes a plurality of anode-mounting terminals and a cathode-mounting terminal, wherein the anode leads are portions of a valve metal pattern which extends in the porous sintered body and which bends at a plurality of locations so as to have a desired path length, and the valve metal pattern portions project out of the porous sintered body;
wherein a first anode lead that is one of the anode leads is electrically connected to a first anode-mounting terminal that is one of the anode-mounting terminals; and
wherein a second anode lead that is one of the anode leads and a third second anode lead that is one of the anode leads are connected to each other in parallel in a path reaching a second anode-mounting terminal that is one of the anode-mounting terminals.

8. The multiterminal solid electrolytic capacitor according to claim 7, wherein the inductance from the first anode-mounting terminal to the porous sintered body is greater than the inductance from the second anode-mounting terminal to the porous sintered body.

9. The multiterminal solid electrolytic capacitor according to claim 7,
wherein the substrate includes a cathode-connecting conductive pattern, a first conductive pattern for anode connection, and a second conductive pattern for anode connection and has a surface which is opposite to a surface that carries the anode-mounting terminals and the cathode-mounting terminal and on which the cathode-connecting conductive pattern, the first conductive pattern, and the second conductive pattern are arranged;
wherein the first conductive pattern and the second conductive pattern are connected to the first anode-mounting terminal and the second anode-mounting terminal, respectively;
wherein the cathode-connecting conductive pattern is connected to the cathode-mounting terminal;
wherein the cathode of the capacitor element is connected to the cathode-connecting conductive pattern;
wherein the first anode lead is connected to the first conductive pattern for anode connection through a first support member for anode lead connection;
wherein the second anode lead is connected to the second conductive pattern for anode connection through a second support member for anode lead connection; and
wherein the third anode lead is connected to the second support member for anode lead connection.

10. The multiterminal solid electrolytic capacitor according to claim 7,
wherein the substrate includes a cathode-connecting conductive pattern, a first conductive pattern for anode connection, a second conductive pattern for anode connection, and a third conductive pattern for anode connection and has a surface which is opposite to a surface that carries the anode-mounting terminals and the cathode-mounting terminal and on which the cathode-connecting conductive pattern, the first conductive pattern, the second conductive pattern, and the third conductive pattern are arranged;
wherein the first conductive pattern, the second conductive pattern, and the third conductive pattern are connected to the first anode-mounting terminal, the second anode-mounting terminal, and a third anode-mounting terminal that is one of the anode-mounting terminals, respectively;
wherein the cathode-connecting conductive pattern is connected to the cathode-mounting terminal;
wherein the cathode of the capacitor element is connected to the cathode-connecting conductive pattern; and
wherein the first anode lead, the second anode lead, and the third anode lead are connected to the first conductive pattern for anode connection, the second conductive pattern for anode connection, and the third conductive pattern for anode connection, respectively, through a first support member for anode lead connection, a second support member for anode lead connection, and a third support member for anode lead connection, respectively.

11. The multiterminal solid electrolytic capacitor according to claim 10, wherein the second and third anode-mounting terminals are connected to each other.

12. A decoupling circuit comprising:
the multiterminal solid electrolytic capacitor according to claim 1,
wherein when the inductance from the porous sintered body to the first anode-mounting terminal through the first anode lead is less than the inductance from the porous sintered body to the first anode-mounting terminal through the second anode lead; and
wherein the first anode-mounting terminal is connected to a power supply and the second anode-mounting terminal is connected to a load.

13. A decoupling circuit comprising:
the multiterminal solid electrolytic capacitor according to claim 5,
wherein the first anode-mounting terminal is connected to a power supply and the second anode-mounting terminal is connected to a load.

14. A multiterminal solid electrolytic capacitor comprising:
a capacitor element including a porous sintered body which includes a plurality of anode leads projecting from the porous sintered body and which is made from a valve metal powder, a dielectric oxide coating disposed on the porous sintered body, and a cathode including a solid electrolyte layer disposed over the dielectric oxide coating; and
a substrate which carries the capacitor element, which includes a plurality of anode-mounting terminals and a cathode-mounting terminal, and which is covered with resin,
wherein the anode leads are portions of a valve metal pattern which extends in the porous sintered body and which bends at a plurality of locations so as to have a desired path length;
wherein the valve metal pattern portions project out of the porous sintered body; and
wherein the inductance of a path extending from one of the mounting terminals to the porous sintered body through one of the anode leads is different from the inductance a path extending from another one of the mounting terminals to the porous sintered body through another one of the anode leads.

15. A decoupling circuit comprising:
the multiterminal solid electrolytic capacitor according to claim 14,
wherein one of the mounting terminals that is connected to a path having a lower inductance is connected to a load and one of the mounting terminals that is connected to a path having a higher inductance is connected to a power supply.

16. A solid electrolytic capacitor comprising.
a porous sintered body which includes a plurality of anode leads projecting from a surface of the porous sintered body and which is made from a valve metal powder;
a dielectric oxide coating disposed on the porous sintered body; and
a cathode including a solid electrolyte layer disposed over the dielectric oxide coating,
wherein the anode leads are portions of a valve metal pattern which extends in the porous sintered body and which bends at a plurality of locations so as to have a desired path length and the valve metal pattern portions project out of the porous sintered body.
